(19) United States
(12) Patent Application Publication
(10) Pub. No.: US 2011/0237727 A1
(43) Pub. Date: Sep. 29, 2011

(54) DURABLE POLYOXYMETHYLENE COMPOSITION

(76) Inventors: Jung-Pao Chang, Kaohsiung County (TW); Chi-En Lin, Taoyuan County (TW)

(21) Appl. No.: 12/820,145

(22) Filed: Jun. 22, 2010

Related U.S. Application Data
(60) Provisional application No. 61/318,784, filed on Mar. 29, 2010.

(51) Int. Cl. C08J 3/20; C08K 5/103; C08K 5/09; C08K 3/26; C08K 3/22; C08K 3/10; C08K 3/36; C08K 3/00

(52) U.S. Cl. 524/317; 524/394; 524/427; 524/432; 524/434; 524/493; 524/497; 524/586; 524/612

(57) ABSTRACT

A durable polyoxymethylene composition and a ramp made of the durable polyoxymethylene composition are disclosed. The durable polyoxymethylene composition of the present invention has excellent micro-wear-resistant property.

### CROSS REFERENCE TO RELATED APPLICATIONS

This application claims the benefit of U.S. Provisional Application Ser. No. 61/318,784, filed Mar. 29, 2010.

### BACKGROUND OF THE INVENTION

1. Field of the Invention

The present invention generally relates to a durable polyoxymethylene composition and a ramp including a durable polyoxymethylene composition. In particular, the present invention is directed to a durable polyoxymethylene composition as well as a ramp including a durable polyoxymethylene composition with excellent micro-wear-resistant property under a high humidity and high temperature condition, or under a low humidity and low temperature condition.

2. Description of the Prior Art

A polyoxymethylene resin is a widely used engineering resin due to its well-balanced mechanical properties, remarkable chemical resistance and sliding properties as well as the good friction wear performance. Recently, attempts have been made to use such polyoxymethylene resin as material for a ramp in a hard disk drive. For example, US 2008/0037175 discloses a ramp including a polyoxymethylene resin and a colorant for a hard disk drive. The ramp has an outgas level of 20 μg/g or less. U.S. Pat. No. 7,088,555 discloses a ramp having a surface hardness of 2.6 GPa or more.

However, in the aforementioned conventional technologies, no description is yet made to a polyoxymethylene resin with excellent micro-wear-resistant properties, and further, no proposal for attempting to reduce wear debris from a polyoxymethylene resin ramp is found.

### SUMMARY OF THE INVENTION

The present invention has the properties of micro-wear resistance, high mechanical stability and high moldability. The function of micro-wear resistance is to decrease the amount of energy necessary for loading/unloading, and also reduces the amount of debris caused when the lift feature of suspension arm rubs against the ramp surface.

The present invention in one aspect provides a durable polyoxymethylene composition. The durable polyoxymethylene composition of the present invention has excellent micro-wear-resistant property. The polyoxymethylene composition of the present invention in one aspect exhibits the micro-wear loss less than 10 μm² wear area, or exhibits the micro-wear loss of 1 μm maximum wear depth under a condition of a load of 2.5 g, reciprocated 600,000 times, at a speed of 8 inch/sec and a low environmental humidity and a low environmental temperature.

The present invention in another aspect provides a durable polyoxymethylene composition. The durable polyoxymethylene composition of the present invention has excellent micro-wear-resistant property. The polyoxymethylene composition of the present invention in another aspect exhibits the micro-wear loss less than 10 μm² wear area or exhibits the micro-wear loss of 1 μm maximum wear depth under a condition of a load of 2.5 g, reciprocated 600,000 times, at a speed of 8 inch/sec and a high environmental humidity and a high environmental temperature.

The present invention in another aspect provides a ramp including a durable polyoxymethylene composition. The ramp of the present invention may exhibit the micro-wear loss less than 10 μm² wear area or exhibit the micro-wear loss of 1 μm maximum wear depth under a condition of a load of 2.5 g, reciprocated 600,000 times, at a speed of 8 inch/sec and a low environmental humidity and a low environmental temperature.

The present invention in another aspect provides a ramp including a durable polyoxymethylene composition. The ramp of the present invention may exhibit the micro-wear loss less than 10 μm² wear area or exhibit the micro-wear loss of 1 μm maximum wear depth under a condition of a load of 2.5 g, reciprocated 600,000 times, at a speed of 8 inch/sec and a high environmental humidity and a high environmental temperature.

In one embodiment of the present invention, the condition of high humidity has a relative humidity in a range from 50% to 60%.

In another embodiment of the present invention, the condition of low humidity has a relative humidity in a range from 13% to 17%.

In one embodiment of the present invention, the condition of high temperature has a temperature in a range from 22° C. to 60° C.

In one embodiment of the present invention, the condition of low temperature has a temperature in a range from 3° C. to 10° C.

The polyoxymethylene composition of the present invention includes:

a polyoxymethylene copolymer of 90.5 wt % to 92.5 wt % including 3.3 wt % of 1,3-dioxolane as a comonomer;
an inorganic filler of 0.5 wt % to 3.0 wt %;
a lubricant of 3.0 wt % to 10.0 wt %;
a nucleating agent of 1.0 wt % to 3.0 wt %;
a stabilizer of 0.5 wt % to 1.0 wt %; and
an anti-static agent of 0.5 wt % to 2.0 wt %.

In the polyoxymethylene composition of the present invention, the polyoxymethylene copolymer may have a tensile strength 62 Mpa (ISO 527) and melt flow rate 27 g/10 min (ISO 1133).

In the polyoxymethylene composition of the present invention, the lubricant may be a modified polyolefin.

In the polyoxymethylene composition of the present invention, the modified polyolefin may be a maleic anhydride modified polyolefin.

In the polyoxymethylene composition of the present invention, the inorganic filler may be nano-grade zinc oxide particles with an average particle size of 100 nm or less.

In the polyoxymethylene composition of the present invention, the nucleating agent may be at least one of a sodium salt of montanic acid and a long chain, linear carboxylic acid. For example, the nucleating agent may be Licomont Cav 102 from Clariant.

In the polyoxymethylene composition of the present invention, the stabilizer may be a mixture of IRGANOX 1010, IRGANOX 259 and IRGANOX 1098 from CIBA, MELAMINE, calcium stearate and PALMOWAX (specification EBS-SP).

In the polyoxymethylene composition of the present invention, the anti-static agent may be a glycerol monostearate.

The polyoxymethylene composition of the present invention may further include an ultra high molecular weight polyethylene of molecular weight 2 million with average particle size 30 μm in a range of 3 wt % to 10 wt %.

The polyoxymethylene composition of the present invention may further include a potassium titanate powder having an average particle size of 1.5 μm in a range of 0.5 wt % to 2.0 wt %.

The polyoxymethylene composition of the present invention may further include a calcium carbonate having a volume average particle diameter of 1 μm in a range of 0.5 wt % to 2.0 wt %.

The polyoxymethylene composition of the present invention may further include a nano-grade silca dioxide with an average particle size of 20 nm in a range of 0.5 wt % to 2.0 wt %.

The polyoxymethylene composition of the present invention may further include a titanium dioxide with an average particle size of 1 μm in a range of 0.5 wt % to 2.0 wt %.

The polyoxymethylene composition of the present invention may further include a stabilizer such as IRGANOX 1010, IRGANOX 259 and IRGANOX 1098 from CIBA, MELAMINE, calcium stearate and PALMOWAX (specification EBS-SP) in a range of 0.5 wt % to 1.0 wt %.

The polyoxymethylene composition of the present invention may further include a low density polyethylene with a melt flow rate 28 g/10 min.

The polyoxymethylene composition of the present invention may be in a form of pellets of 2 mm by 3 mm dimension.

The polyoxymethylene composition of the present invention may be in a form of a hollow column.

These and other objectives of the present invention will no doubt become obvious to those of ordinary skill in the art after reading the following detailed description of the preferred embodiment that is illustrated in the various figures and drawings.

### DETAILED DESCRIPTION

The present invention generally relates to a durable polyoxymethylene composition as well as a load/unload ramp structure. Load/unload ramp structure is use to keep a magnetic head away from the rotating disk. A suspension arm holds a magnetic head for reading and writing of information from and to an information recording disk rotating at a high speed in a hard disk drive. In a recent hard disk drive, there is provided a ramp as a magnetic-head retraction location where the head is held as spaced from a recording disk when the disk is in its inoperable mode.

The present invention in a first aspect provides a durable polyoxymethylene composition. The durable polyoxymethylene composition of the present invention has excellent micro-wear-resistant property. The polyoxymethylene composition of the present invention in one aspect exhibits the micro-wear loss less than 10 μm² wear area or 1 μm maximum wear depth under a condition of a load of 2.5 g, reciprocated 600,000 times, at a speed of 8 inch/sec and a low environmental humidity and a low environmental temperature.

In another embodiment of the present invention, the condition of low humidity has a relative humidity in a range from 13% to 17%. In another embodiment of the present invention, the condition of low temperature has a temperature in a range from 3° C. to 10° C. In one preferred embodiment of the present invention, the polyoxymethylene composition forms a ramp for use in a hard drive.

The present invention in another aspect provides another durable polyoxymethylene composition. The durable polyoxymethylene composition of the present invention also has excellent micro-wear-resistant property. The polyoxymethylene composition of the present invention in another aspect exhibits the micro-wear loss less than 10 μm² wear area or 1 μm maximum wear depth under a condition of a load of 2.5 g, reciprocated 600,000 times, at a speed of 8 inch/sec and a high environmental humidity and a high environmental temperature.

In one embodiment of the present invention, the condition of high humidity has a relative humidity in a range from 50% to 60%. In another embodiment of the present invention, the condition of high temperature has a temperature in a range from 22° C. to 60° C. In one preferred embodiment of the present invention, the polyoxymethylene composition forms a ramp for use in a hard drive.

The polyoxymethylene composition of the present invention includes some components, such as a polyoxymethylene copolymer, an inorganic filler, a lubricant, a nucleating agent, a stabilizer, and an anti-static agent. The polyoxymethylene composition includes the polyoxymethylene copolymer of 90.5 wt % to 92.5 wt % including 3.3 wt % of 1,3-dioxolane as a comonomer. For example, the polyoxymethylene copolymer may have a tensile strength 62 Mpa (ISO 527) and melt flow rate 27 g/10 min (ISO 1133).

The polyoxymethylene composition may include a lubricant of 3.0 wt % to 10.0 wt %. For example, the lubricant may be a modified polyolefin, such as a maleic anhydride modified polyolefin. The polyoxymethylene composition of the present invention may further include a low density polyethylene with a melt flow rate 28 g/10 min. In addition, the polyoxymethylene composition of the present invention may further include an ultra high molecular weight polyethylene of molecular weight 2 million with average particle size 30 μm in a range of 3 wt % to 10 wt %.

There may be various and different inorganic fillers. For example, one suitable inorganic filler may be nano-grade zinc oxide particles of 0.5 wt % to 3.0 wt % with an average particle size of 100 nm or less. The polyoxymethylene composition of the present invention may include other suitable inorganic filler (s) of different wt %, such as potassium titanate powder having an average particle size of 1.5 μm in a range of 0.5 wt % to 2.0 wt %, calcium carbonate having a volume average particle diameter of 1 μm in a range of 0.5 wt % to 2.0 wt %, nano-grade silca dioxide with an average particle size of 20 nm in a range of 0.5 wt % to 2.0 wt %, titanium dioxide with an average particle size of 1 μm in a range of 0.5 wt % to 2.0 wt %, or the combination thereof.

The polyoxymethylene composition includes the nucleating agent of 1.0 wt % to 3.0 wt %. For example, the nucleating agent may be at least one of a sodium salt of montanic acid and a long chain, linear carboxylic acid. For example, the nucleating agent may be Licomont Cav 102 from Clariant.

The polyoxymethylene composition includes the stabilizer of 0.5 wt % to 1.0 wt %, such as at least one of an antioxidant and an acid scavenger. For example, the stabilizer may be a mixture of IRGANOX 1010, IRGANOX 259 and IRGANOX 1098 from CIBA, MELAMINE, calcium stearate and PALMOWAX (specification EBS-SP).

The polyoxymethylene composition includes the anti-static agent of 0.5 wt % to 2.0 wt %. For example, the anti-static agent may be a glycerol monostearate.

In addition to being processed to form a ramp, the polyoxymethylene composition of the present invention may also be processed to form pellets. For example, the pellets may be hollow columns of 2 mm by 3 mm dimension. The pellets are advantageous for use in transportation or in storage. The pellets may be later processed to form ramps when needed.

Some examples are given here to demonstrate the steps to formulate and to form the micro-wear-resistant polyoxymethylene composition of the present invention.

### Example 1

Materials (A) polyoxymethylene copolymer (90.5 wt. %); (B) a lubricant of LDPE (melt flow rate 28 g/10 min (ISO 1133)) (5.0 wt. %); an inorganic filler of (C-1) nano-grade calcium carbonate (1.0 wt. %) and (C-3) nano-grade silicon dioxide (1.0 wt. %); (D) a nucleating agent Licomont Cav 102 from Clariant (2.0 wt %) and (E) a stabilizer IRGANOX 1010, IRGANOX 259 and IRGANOX 1098 from CIBA, MELAMINE, calcium stearate and PALMOWAX (0.5 wt %) were well mixed in a high speed vertical mixer for 2 min. The mixed materials (5 KG) were placed in a raw material tank after mixing.

The mixed materials were fed into a twin screw extruders (φ=44 mm) by a feeder. The feeding was set to be 35 kg/hr. The extruder barrel was adjusted to 160-220° C. The vacuum was adjusted to 10-30 cm Hg. The melted composition were cooled and cut to be pellets in the form of 3 mm*2 mm, then dried by a hot blow dryer at 130° C. for 4 hours. The pellets were injected to form ramps of 0.17 g, 11.6×6.2×5.2 mm each piece. The ramps were washed in an ultrasonic cleaner (first stage in a 1% surfactant VALTRON® DP97031, second to fifth stages in deionized water, 8 min in each stage). The wet ramps were dried in a cyclone type oven at 85° C. for 8 min., then dried in a dry oven at 85° C. for 1 hour. The ramps were subject to various tests. The results were listed in Table 2.

### Example 2

Methods which are similar to those of Example 1 were used except that (A) polyoxymethylene copolymer (91.0 wt. %); (B-1) a lubricant of a maleic anhydride modified polyolefin (7.0 wt. %); (C) an inorganic filler of potassium titanate powder (0.5 wt. %); (D) a nucleating agent Licomont Cav 102 from Clariant (1.0 wt %); and (E) a stabilizer IRGANOX 1010, IRGANOX 259 and IRGANOX 1098 from CIBA, MELAMINE, calcium stearate and PALMOWAX (0.5 wt %). The ramps were subject to various tests. The results were also listed in Table 2.

### Example 3

Methods which are similar to those of Example 1 were used except that (A) polyoxymethylene copolymer (91.0 wt. %); (B-2) a lubricant of UHMWPE (molecular weight 2 million (ASTM D4020) with average particle size 30 μm) (7.0 wt. %); (C) an inorganic filler of potassium titanate powder (0.5 wt. %); (D) a nucleating agent Licomont Cav 102 from Clariant (1.0 wt %) and (E) a stabilizer IRGANOX 1010, IRGANOX 259 and IRGANOX 1098 from CIBA, MELAMINE, calcium stearate and PALMOWAX (0.5 wt %). The ramps were subject to various tests. The results were also listed in Table 2.

### Example 4

Methods which are similar to those of Example 1 were used except that (A) polyoxymethylene copolymer (92.5 wt. %); (B-1) a lubricant of a maleic anhydride modified polyolefin (5.0 wt. %); (C-4) an inorganic filler of titanium dioxide powder (1.0 wt. %); (D) a nucleating agent Licomont Cav 102 from Clariant (1.0 wt %) and (E) a stabilizer IRGANOX 1010, IRGANOX 259 and IRGANOX 1098 from CIBA, MELAMINE, calcium stearate and PALMOWAX (0.5 wt %). The ramps were subject to various tests. The results were also listed in Table 2.

### Example 5

Methods which are similar to those of Example 1 were used except that (A) polyoxymethylene copolymer (91.5 wt. %); (B-1) a lubricant of a maleic anhydride modified polyolefin (5.0 wt. %); (C-2) an inorganic filler of nano-grade zinc oxide (1.0 wt. %); (D) a nucleating agent Licomont Cav 102 from Clariant (1.0 wt %) and (E) a stabilizer IRGANOX 1010, IRGANOX 259 and IRGANOX 1098 from CIBA, MELAMINE, calcium stearate and PALMOWAX (1.0 wt %) with additional (F) an anti-static agent glycerol monostearate of 1.0 wt %. The ramps were subject to various tests. The results were also listed in Table 2.

### Comparative Example 1

A raw material, polyoxymethylene resin pellets (Polyplastics-Duracon M9044) were dried at 100° C. for 4 hrs. The pellets were injected to form ramps of 0.41 g, 13.5×8.8×8.6 mm each piece. The ramps were washed in an ultrasonic cleaner (first stage in a 1% surfactant VALTRON® DP97031, second to fifth stages in deionized water, 8 min in each stage). The wet ramps were dried in a cyclone type oven at 85° C. for 8 min., then dried in a dry oven at 85° C. for 1 hour. The ramps were subject to various tests. The results were listed in Table 3.

### Comparative Example 2

A raw material, polyoxymethylene resin pellets (DuPont-Derlin 500P) were dried at 100° C. for 4 hrs. The pellets were injected to form ramps of 0.17 g, 11.6×6.2×5.2 mm each piece. The ramps were washed in an ultrasonic cleaner (first stage in a 1% surfactant VALTRON® DP97031, second to fifth stages in deionized water, 8 min in each stage). The wet ramps were dried in a cyclone type oven at 85° C. for 8 min., then dried in a dry oven at 85° C. for 1 hour. The ramps were subject to various tests. The results were listed in Table 3.

TABLE 1

| Compositions of Ex-1 to Ex-5 | | | Ex-1 | Ex-2 | Ex-3 | Ex-4 | Ex-5 |
|---|---|---|---|---|---|---|---|
| ingre- | Polyoxy- | coplymer | 90.5 | 91 | 91 | 92.5 | 91.5 |
| dients | methylene | | | | | | |
| | B. Lubricant | LDPE | 5 | — | — | — | — |
| | (2)* | | | | | | |
| | B-1 | Modified PE | — | 7 | — | 5 | 5 |
| | | (polyolefin) | | | | | |
| | B-2 | UHMWPE | — | — | 7 | — | — |
| | C. Inorganic | Potassium | — | 0.5 | 0.5 | — | — |
| | filler | Titanate | | | | | |
| | | powder | | | | | |
| | C-1 | CaCO₃ | 1 | — | — | — | — |
| | C-2 | Nano ZnO | — | — | — | — | 1 |
| | C-3 | Nano SiO₂ | 1 | — | — | — | — |
| | C-4 | TiO2 powder | — | — | — | 1 | — |
| | D. Nucleating | Licomont Cav | 2 | 1 | 1 | 1 | 1 |
| | agent | 102 | | | | | |
| | E. Stabilizers | (1)* | 0.5 | 0.5 | 0.5 | 0.5 | 0.5 |
| | F. Anti-static | glycerol | — | — | — | — | 1 |
| | agent | monostearate | | | | | |
| Results | Physical | Melt flow | 27 | 24 | 25 | 26.2 | 24.7 |
| | | rate | | | | | |
| | | (ISO 1133) | | | | | |
| | properties | Tensile | 60 | 59 | 52 | 59 | 58.2 |
| | | strength | | | | | |
| | | (ISO 527-1, 2) | | | | | |
| | | Tensile | 23 | 25 | 18 | 24 | 26.4 |
| | | elongation | | | | | |
| | | (ISO 527-1, 2) | | | | | |
| | | Flexural | 88 | 82 | 75 | 82 | 80 |
| | | strength | | | | | |
| | | (ISO 178) | | | | | |
| | | Charpy Impact | 6 | 8 | 6 | 8 | 9.1 |
| | | (ISO 179/1eA) | | | | | |

Remark: (1)* mixture of IRGANOX 1010, IRGANOX 259 and IRGANOX 1098 from CIBA, MELAMINE, calcium stearate and PALMOWAX (specification EBS-SP).
(2)* The ingredient (B) is a lubricant, which may be a LDPE, an modified PE, or a UHMWPE. The ingredient (C) is an inorganic filler, which may be a potassium titanate powder, CaCO₃, nano ZnO, Nano SiO₂, or TiO₂ powder.

The following test results are carried out under a condition of after being reciprocated 600,000 times:

(1) at a load of 2.5 g;
(2) at a speed of 8 inch/sec;
(3) under an environmental low humidity or high humidity; and
(4) under an environmental low temperature, room temperature or high temperature.

TABLE 2

| | Example 1 | Example 2 | Example 3 | Example 4 |
|---|---|---|---|---|
| Condition | (A) | (A) | (A) | (A) |
| | 5° C. ± 2° C. | 5° C. ± 2° C. | 5° C. ± 2° C. | 5° C. ± 2° C. |
| | 15% ± 3% | 15% ± 3% | 15% ± 3% | 15% ± 3% |
| | RH | RH | RH | RH |
| Maximum | 0.3890 | 0.3301 | 0.2474 | 0.2292 |
| wear | 0.4466 | 0.3279 | 0.3446 | 0.2844 |
| depth | 0.9180 | 0.4028 | 0.1547 | 0.5014 |
| | 0.3702 | 0.3473 | 0.0785 | 0.2244 |
| Wear | 4.4868 | 9.2383 | 1.7316 | 1.4760 |
| Area | 3.9027 | 7.1192 | 8.2014 | 1.5837 |
| | 5.7947 | 5.2397 | 1.1880 | 6.4781 |
| | 6.3641 | 7.4159 | 0.8134 | 9.6901 |

Remarks:
1. (A) low humidity/low temperature;
(B) high humidity/high temperature;
(C) room temperature.
2. The data was measured by Wyko (MHT-III) machine (Different brands machine might have different test results).
3. The parts were tested by CETR Micro-Tribometer UMT (Load/Unload model) with suspension component.

Example 1 demonstrates a primary evaluation of the polyoxymethylene composition of the present invention. Example 2-4 are further modified and improved in accordance with Example 1. Example 5 demonstrates excellent micro-wear-resistant properties in comparison to the comparative examples. Example 5 exhibits excellent micro-wear-resistant properties in both (A) low humidity/low temperature condition, (B) high humidity/high temperature condition and (C) room temperature. Example 5 also generates least wear debris to show excellent micro-wear-resistant properties in (A) low humidity/low temperature condition, (B) high humidity/high temperature condition and (C) room temperature.

TABLE 2
(Continued)

| | Example 5 | | | |
|---|---|---|---|---|
| Condition | (A) | (A) | (C) | (B) |
| | 5° C. ± 2° C. | 10° C. ± 2° C. | 25° C. ± 3° C. | 55° C. ± 5° C. |
| | 15% ± 3% | 15% ± 3% | 55% ± 5% | 55% ± 5% |
| | RH | RH | RH | RH |
| Maximum | 0.0888 | 0.1740 | 0.0573 | 0.0735 |
| wear | 0.0915 | 0.2216 | 0.2277 | 0.1274 |
| depth | 0.1752 | 0.2181 | 0.0820 | 0.2216 |
| | 0.2100 | 0.1137 | 0.1091 | 0.2291 |
| Wear | 1.5791 | 3.9492 | 0.4437 | 0.8667 |
| Area | 1.4484 | 3.4538 | 1.8543 | 1.7613 |
| | 2.0638 | 2.5785 | 1.6032 | 1.8775 |
| | 3.2159 | 2.2625 | 0.4718 | 2.0090 |

Remarks:
1. (A) low humidity/low temperature;
(B) high humidity/high temperature;
(C) room temperature.
2. The data was measured by Wyko (MHT-III) machine (Different brands machine might have different test results).
3. The parts were tested by CETR Micro-Tribometer UMT (Load/Unload model) with suspension component.

TABLE 3

| | Comparative Example 1 | | | |
|---|---|---|---|---|
| Condition | (A) | (C) | | (B) |
| | 5° C. ± | 25° C. ± | | 55° C. ± |
| | 2° C. | 3° C. | | 5° C. |
| | 15% ± | 55% ± | | 55% ± |
| | 3% | 5% | | 5% |
| | RH | RH | | RH |
| Maximum | 1.8854 | 0.3795 | | 0.2768 |
| wear | 2.2465 | 0.3597 | | 0.4282 |
| depth | 1.8726 | 0.2569 | | 0.4215 |
| | 1.8947 | 0.4435 | | 0.6491 |
| Wear | 181.2939 | 13.1565 | | 4.7282 |
| Area | 172.5484 | 9.1015 | | 17.1287 |
| | 161.4402 | 7.2146 | | 7.8671 |
| | 180.5232 | 8.5611 | | 19.7332 |
| | Comparative Example 2 | | | |
| Condition | (A) | (A) | (C) | (B) |
| | 5° C. ± | 10° C. ± | 25° C. ± | 55° C. ± |
| | 2° C. | 2° C. | 3° C. | 5° C. |
| | 15% ± | 15% ± | 55% ± | 55% ± |
| | 3% | 3% | 5% | 5% |
| | RH | RH | RH | RH |
| Maximum | 2.5730 | 2.5730 | 0.7733 | 0.3698 |
| wear | 2.0564 | 1.6634 | 1.0455 | 0.5261 |
| depth | 1.8703 | 2.1453 | 1.5200 | 0.6344 |
| | 2.1701 | 1.4446 | 1.1794 | 0.8624 |
| Wear | 99.8968 | 99.8968 | 15.3849 | 9.0576 |
| Area | 76.3102 | 98.7693 | 24.8515 | 12.0457 |
| | 60.1881 | 85.8774 | 42.3004 | 12.4023 |
| | 85.8774 | 86.7332 | 29.6912 | 14.6838 |

Remarks:
1. (A) low humidity/low temperature;
(B) high humidity/high temperature;
(C) room temperature.
2. The data was measured by Wyko (MHT-III) machine (Different brands machine might have different test results).
3. The parts were tested by CETR Micro-Tribometer UMT (Load/Unload model) with suspension component.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A polyoxymethylene composition, which has at least one of the micro-wear loss of less than 1 μm maximum wear depth or less than 10 μm² wear area under a condition of a load of 2.5 g after being reciprocated 600,000 times at a speed of 8 inch/second and an environmental humidity of 13% to 17% RH and an environmental temperature of 3° C. to 10° C., the polyoxymethylene composition comprising:
a polyoxymethylene copolymer of 90.5 wt % to 92.5 wt % including 3.3 wt % of 1,3-dioxolane as a comonomer;
an inorganic filler of 0.5 wt % to 3.0 wt %;
a lubricant of 3.0 wt % to 10.0 wt %;
a nucleating agent of 1.0 wt % to 3.0 wt %;
a stabilizer of 0.5 wt % to 1.0 wt %; and
an anti-static agent of 0.5 wt % to 2.0 wt %.

2. The polyoxymethylene composition of claim 1, wherein said lubricant is a modified polyolefin.

3. The polyoxymethylene composition of claim 2, wherein the modified polyolefin comprises a maleic anhydride modified polyolefin.

4. The polyoxymethylene composition of claim 1, wherein said inorganic filler comprises nano-grade zinc oxide particles with an average particle size not greater than 100 nm.

5. The polyoxymethylene composition of claim 1, wherein the nucleating agent comprises at least one of a sodium salt of montanic acid and a long chain, linear carboxylic acid.

6. The polyoxymethylene composition of claim 1, wherein the stabilizer comprises at least one of an antioxidant and an acid scavenger.

7. The polyoxymethylene composition of claim 1, wherein the anti-static agent comprises a glycerol monostearate.

8. The polyoxymethylene composition of claim 1 further comprising an ultra high molecular weight polyethylene having a molecular weight of 2 million with an average particle size of 30 μm in a range of 3 wt % to 10 wt %.

9. The polyoxymethylene composition of claim 1 further comprising: potassium titanate powder having an average particle size of 1.5 μm in a range of 0.5 wt % to 1.0 wt %.

10. The polyoxymethylene composition of claim 1 further comprising: calcium carbonate having a volume average particle diameter of 1 μm in a range of 0.5 wt % to 2.0 wt %.

11. The polyoxymethylene composition of claim 1 further comprising: nano-grade silca dioxide with an average particle size of 20 nm in a range of 0.5 wt % to 2 wt %.

12. The polyoxymethylene composition of claim 1 further comprising: titanium dioxide with an average particle size of 1 μm in a range of 0.5 wt % to 2 wt %.

13. The polyoxymethylene composition of claim 1 further comprising: a low density polyethylene of (5%) with a melt flow rate 28 g/10 min.

14. A ramp which has at least one of the micro-wear loss of less than 1 μm maximum wear depth and of less than 10 μm² wear area under a condition of a load of 2.5 g after being reciprocated 600,000 times at a speed of 8 inch/sec and an environmental humidity of 13% to 17% RH) and an environmental temperature of 3° C. to 10° C., the ramp comprising:
a polyoxymethylene copolymer of 90.5 wt % to 92.5 wt % including 3.3 wt % of 1,3-dioxolane as a comonomer;
an inorganic filler of 1.0 wt % to 3.0 wt %;
a lubricant of 3.0 wt % to 10.0 wt %;
a nucleating agent of 1.0 wt % to 3.0 wt %;
a stabilizer of 0.5 wt % to 1.0 wt %; and
an anti-static agent of 0.5 wt % to 2.0 wt %.

15. A micro-wear-resistant polyoxymethylene composition which has at least one of the micro-wear loss of less than 0.5 μm maximum wear depth and of less than 5 μm² wear area under a condition of a load of 2.5 g after being reciprocated 600,000 times at a speed of 8 inch/sec and an environmental humidity of 50% to 60% RH and an environmental temperature of 22° C. to 60° C., the micro-wear-resistant polyoxymethylene composition comprising:
a polyoxymethylene copolymer of 90.5 wt % to 92.5 wt % including 3.3 wt % of 1,3-dioxolane as a comonomer;
an inorganic filler of 0.5 wt % to 3.0 wt %;
a lubricant of 3.0 wt % to 10.0 wt %;
a nucleating agent of 1.0 wt % to 3.0 wt %;
a stabilizer of 0.5 wt % to 1.0 wt %; and
an anti-static agent of 0.5 wt % to 2.0 wt %.

16. The polyoxymethylene composition of claim 15, wherein said lubricant is a modified polyolefin.

17. The polyoxymethylene composition of claim 16, wherein the modified polyolefin comprises a maleic anhydride modified polyolefin.

18. The polyoxymethylene composition of claim 15, wherein said inorganic filler is nano-grade zinc oxide particles with an average particle size not greater than 100 nm.

19. The polyoxymethylene composition of claim 15, wherein the nucleating agent comprises at least one of a sodium salt of montanic acid and a long chain, linear carboxylic acid.

20. The polyoxymethylene composition of claim 15, wherein the stabilizer comprises at least one of an antioxidant and an acid scavenger.

21. The polyoxymethylene composition of claim 15, wherein the anti-static agent comprises a glycerol monostearate.

22. The polyoxymethylene composition of claim 15, further comprising: an ultra high molecular weight polyethylene of molecular weight 2 million with average particle size 30 μm in a range of 3 wt % to 10 wt %.

23. The polyoxymethylene composition of claim 15, further comprising: potassium titanate powder having an average particle size of 1.5 μm in a range of 0.5 wt % to 1.0 wt %.

24. The polyoxymethylene composition of claim 15, further comprising: calcium carbonate having a volume average particle diameter of 1 μm in a range of 0.5 wt % to 2.0 wt %.

25. The polyoxymethylene composition of claim 15, further comprising: nano-grade silca dioxide with an average particle size of 20 nm in a range of 0.5 wt % to 2 wt %.

26. The polyoxymethylene composition of claim 15, further comprising: titanium dioxide with an average particle size of 1 μm in a range of 0.5 wt % to 2.0 wt %.

27. The polyoxymethylene composition of claim 15, further comprising: a low density polyethylene with a melt flow rate 28 g/10 min.

28. A ramp which has at least one of the micro-wear loss of less than 0.5 μm maximum wear depth and of less than 5 μm² wear area under a condition of a load of 2.5 g after being reciprocated 600,000 times at a speed of 8 inch/sec and an environmental humidity of 50%-60% RH and an environmental temperature of 22° C. to 60° C., the ramp comprising:
a polyoxymethylene copolymer of 90.5 wt % to 92.5 wt % including 3.3 wt % of 1,3-dioxolane as a comonomer;
an inorganic filler of 0.5 wt % to 3.0 wt %;
a lubricant of 3.0 wt % to 10.0 wt %;
a nucleating agent of 1.0 wt % to 3.0 wt %;
a stabilizer of 0.5 wt % to 1.0 wt %; and
an anti-static agent of 0.5 wt % to 2.0 wt %.
